(19) United States
(12) Patent Application Publication
(10) Pub. No.: US 2015/0287255 A1
(43) Pub. Date: Oct. 8, 2015

(54) SMART DATA CARDS AND MEDICAL KEYRINGS ENABLE THE PERFORMANCE OF VARIOUS FUNCTIONS UPON ACTIVATION/AUTHENTICATION BY A USER'S FINGERPRINT AND BY FACIAL RECOGNITION OF THE USER, OR BY FACIAL RECOGNITION OF A USER ALONE

(71) Applicant: Chaya Coleena Hendrick, Surfside, FL (US)

(72) Inventor: Chaya Coleena Hendrick, Surfside, FL (US)

(21) Appl. No.: 13/974,826

(22) Filed: Aug. 23, 2013

(51) Int. Cl. G07C 9/00

(52) U.S. Cl. CPC G07C 9/00158

(57) ABSTRACT

A card such as an EMV card that connects, wirelessly or by contact, to a reader or to a computing device, mobile telephone or cellular telephone, and permits the flow of data to/from card when connected to such a reader or computing device, after both fingerprint scanning authorization/user verification system, and image scanning authorization/user verification, or after image scanning authorization/user verification alone.

This application relates to U.S. patent application Ser. No. 13/445,608, filed Apr. 12, 2012, in the United States Patent and Trademark Office. We hereby incorporate here by reference that entire application as though fully set forth here.

This invention relates to smart data cards such as EMV contact or contactless debit and credit cards, or other memory device such as a banking, debit, or credit card, that requires activation or authentication before use. Such activation or authentication may take place upon facial recognition, as with a small camera in/on the card, or upon both facial recognition and fingerprint recognition. This card may be inserted into, or otherwise connected, e.g. wirelessly, to a reader, or to a connector device, or to a portable computing device such as an iPhone or an iPad, or to other smart phones, and computing pads.

Some connector devices may include an internal reading interface for an IC chip in or on the memory device, allowing the connector to be used to read data from the card via this chip. Pin or other connectors on the memory device may allow for the connection and bi-directional/uni-directional flow of power and/or digital data from a mobile phone through to the attached memory device, meaning this flow/communication may be one-way or two-way. These cards may permit payments from an ATM or other cash dispenser/receiver, and may be used to pay for any goods or services, wirelessly, through contact, or otherwise.

Fingerprint authentication/activation may be effected as follows: 1. a user touches a fingerprint scanning sensor on the surface of one or more of these devices; 2. the sensor transmits fingerprint data to an internal processor and memory of one or more of the devices; and 3. the user's fingerprint is compared to one or more stored fingerprint databases in one or more of these devices. If comparison produces a match between the sensed fingerprint and a stored fingerprint, activation/authentication occurs

These cards may include memory or other storage for a photograph/image of a person or another image. The card may include an attached camera or a built-in camera to capture such an image. An image of a person or something else may be taken with the computing device's camera. This newly-taken image is processed by software on a card reader, and tested for matching with previously-stored images on the card or other storage medium. Computer coding may control such testing, e.g., photographic recognition software.

For two-factor match/authentication/verification, a fingerprint scanner may be in/on a card. A user touches a sensor on the card to read a person's fingerprint, followed by comparison with previously-stored fingerprints. The same user may also undergo picture capture and matching. Both fingerprint and picture are compared with stored fingerprints and stored pictures. If a match of both fingerprint and picture occurs, then prescribed functions may be activated/authenticated for the card. Alternatively, in a single-factor match/verification, only a photograph match may be required.

Another match/authentication/verification method for use with fingerprint or image verification may use voice pattern recognition. A voice pattern recording is made by each communication participant for use as an encryption key. All participants sign on to a voice session, and a voice pattern may be captured of such participants with the repeating of a variable revolving computer generated sentence. Next, all participants enter a computer generated code. The resulting code keys may be used as voice scramble/unscramble keys. Interception of these keys by others would deliver an unrecognizable message.

Multi-factor authentication may also be embodied in a medical keyring device that may include a hole allowing use as a keyring. Such devices may vary in size, but are preferably small enough for carrying in a purse or pocket, e.g., a device with dimensions of less than six inches long, two inches high and four inches wide. These devices may include an inbuilt screen for displaying information such as emergency medical information. These devices may also include an on/off switch

Some embodiments may include a USB connector for connecting with computer devices via a USB port or adaptor that, in turn, connects the medical keyring and a computer. Optionally such devices may include an inbuilt wi-fi chip to provide communication to computers, tablets and/or telephones via wi-fi. These devices may include an internal software records system for managing medical records internally. These devices may also include an embedded silicon sensor, connected to an internal processor, that may process scanning and capture of a medical keyring owner's fingerprint. These devices may include an internal rechargeable power supply that powers an internal processor, embedded sensor, or both.

These devices may include an internal memory for storage of images and text, or of a user's fingerprint. Such fingerprints may also be stored in memory connected to the device's internal processor.

Upon initial activation of such devices, a user may be prompted, as by a digital display on the device's display screen, to swipe their finger over the device's fingerprint sensor. So doing captures/stores the person's fingerprint in the device's internal memory, and may preclude capturing/storing any other fingerprint unless the stored fingerprint is removed. Alternatively, the device may prompt for two separate fingerprints, which can each separately activate the same or different functions of the keyring. After capture/storage of one or more fingerprints, a user may be prompted to insert the device into a computer/computing device USB port or adaptor, causing a device manager to appear on the screen. A user may then be prompted to input information to the device manager. Such information may then be stored in the medical keyring's internal memory.

In some embodiments, a user may upload, from a computer/computing device, or otherwise, into the internal memory of a medical keyring, images, photographs, and videos such as X-rays, mammograms, cat scans, and ultra sound. Medical text records, such as a user's identifiers and insurers, and a user's treatment history, may likewise be uploaded into the medical keyring's memory. Stored images and records may thereafter be viewed and/or downloaded only after a user activates memory by single or dual authentication.

Information/images stored in the memory of the keyring may be sent over the internet to an insurer, who may use treatment history and/or other information to verify the need for user care, and to minimize fraud. For example, when a user first enters their name, date of birth, address and/or health insurance provider name and user ID number on an information manager screen on their computer/computing device for keyring storage, the information may be compared with information stored elsewhere for verification, over the Internet or otherwise. Absent a match, any difference may be flagged, and a prompt may be sent seeking correction/explanation.

In some embodiments, a contactless transaction card, e.g. a banking/credit/debit card, bearing an RFID or other wireless chip, is moved near to an RFID or other wireless reader to read the card's data. In other embodiments, a card may be read by insertion of the card into a connector device. Insertion causes contact between a surface-mounted device, e.g. chip on the card, and reading contacts inside the connector device. Communication ensues after fingerprint/image recognition/activation, as described above.

Two or more of such cards may be configured to communicate wirelessly with one another, or to transfer funds between them upon user activation of sender and recipient cards. Such transfers may also take place between a card and a mobile device, or between two mobile devices that can connect to such cards.

### BRIEF DESCRIPTION OF THE DRAWINGS

The following drawings illustrate several embodiments of the invention, but the claims are not limited to these embodiments. These drawings include:

FIGS. 1A to 1D and 2A and 2B show embodiments of the cards of this invention connected to connector devices and to computing devices;

FIG. 3 shows a data card reader embodiment for connection to a data card;

FIG. 4 shows a data card connected to a computing device where the card includes a camera and image recognition/verification system for comparing a prospective user's face to stored images, and also includes a fingerprint recognition/verification system;

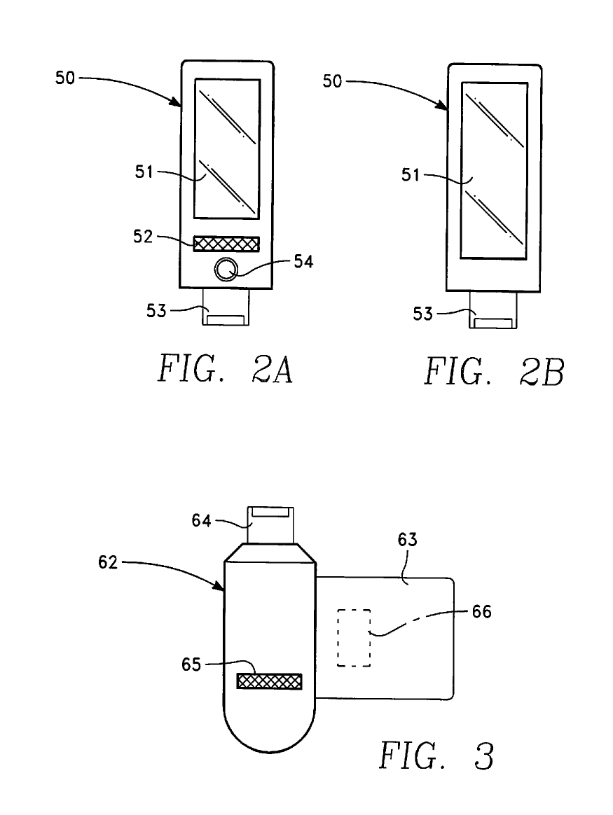

FIG. 5 shows a data card embodiment for wirelessly communicating with an authorized Wi-Fi connected device;

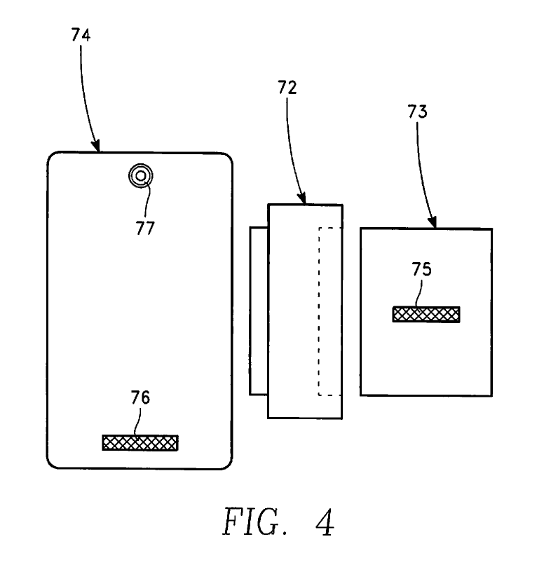

FIG. 6 shows an embodiment of a data card that can communicate with other such cards; and

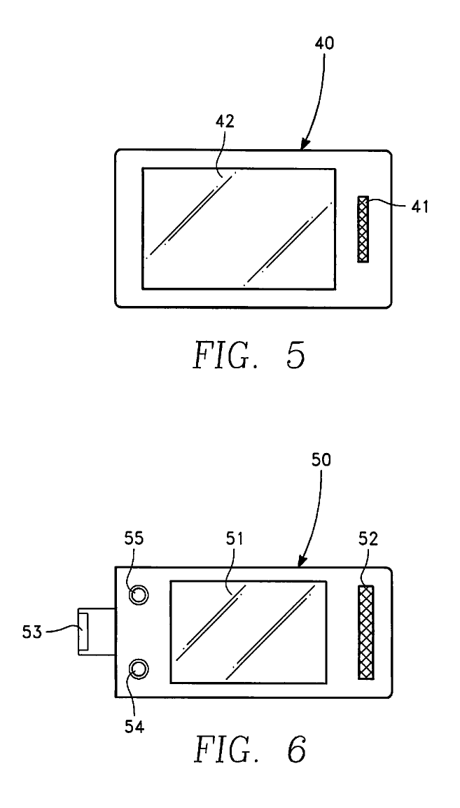

FIGS. 7A and 7B shows a purse-sized/pocket-sized embodiment of the medical key ring of this invention, including a display screen, an on/off switch, and a USB connector.

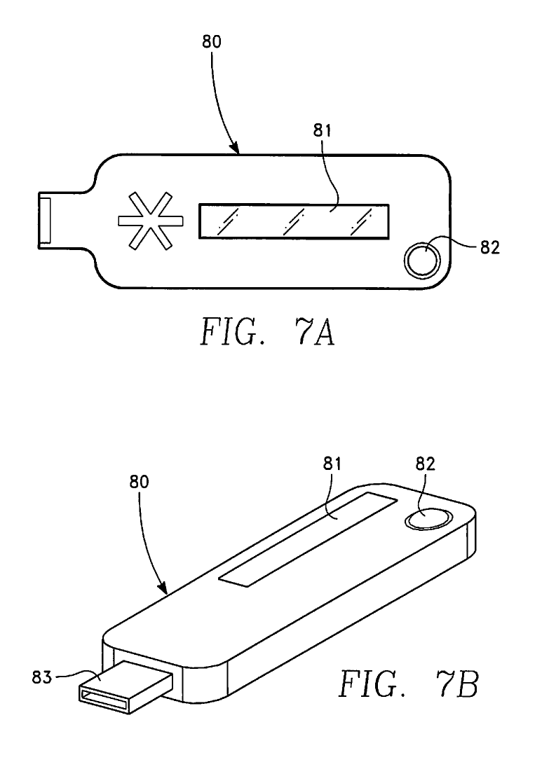

### DETAILED DESCRIPTION OF THE DRAWINGS

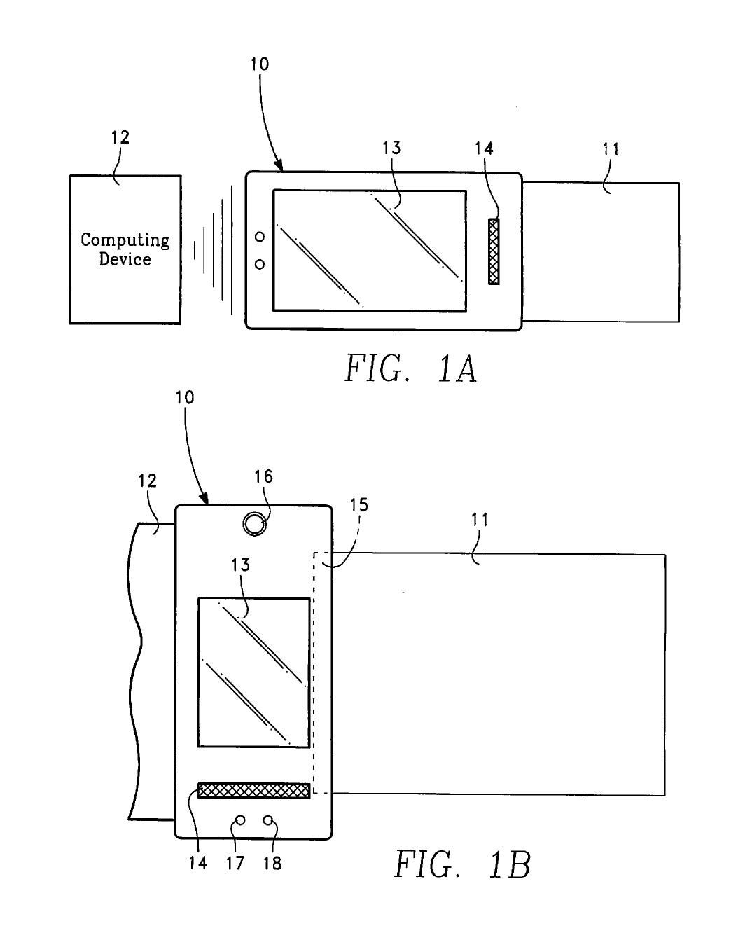

FIG. 1 shows card 1 with fingerprint verification/authorization sensor 2 and image verification/authorization sensor 3 for connection to a reader or to a computing device. Card 1 includes IC chip 4. To activate card 1, a user touches his fingerprint to sensor 2, and displays his or another designated image to sensor 3, and a processor in card 1 compares the user's print and the sensed image to a database, in memory on card 1, of stored, known images and prints. If a match to an authorized user's print and to the displayed image occurs, card 1 is activated, and data can flow to/from card 1.

FIG. 2 shows data card 100 carrying data storage chip 101 and image authentication/verification sensor 102. Card 100 may be an EMV credit card, debit card, or pre-paid card. Card 100 may connect wirelessly, on paths 103, 104, 105 and 106 to an Internet connected device 107, to an Internet connected phone 108, to an Internet access point 109, or to a PAD/computer 110, and to the Internet/web/cloud 115 on paths 111, 112, 113, and 114 for device 107, phone 108, access point 109, or PAD/computer 110. Internet connection 115 then provides access to banks 116, merchants 117 and others, such as pre-paid card refill 118, to fulfill a desired transaction.

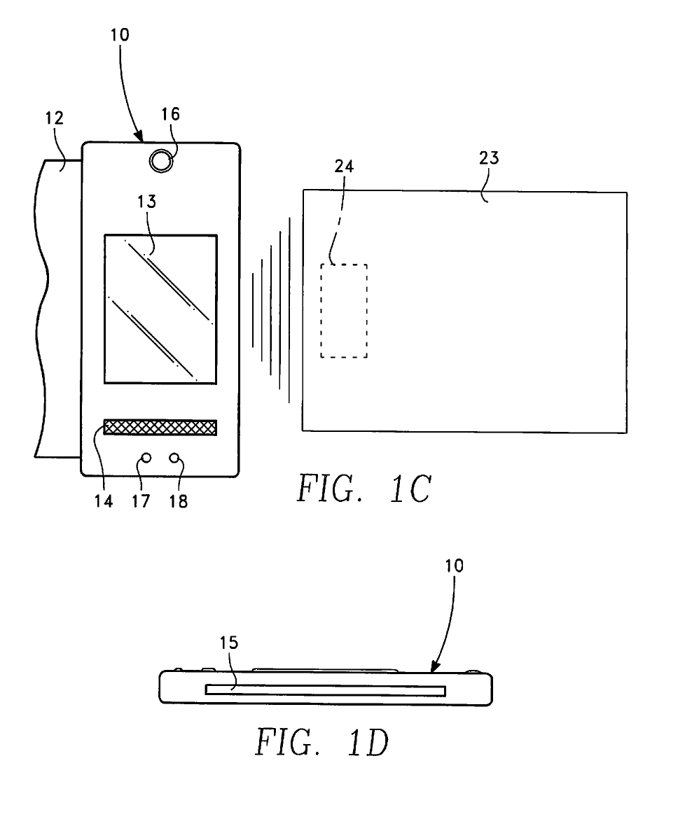

FIG. 3 shows data card 200 carrying data storage chip 201, and image authorization/verification sensor 202. Such data cards, after authorization/verification, may communicate wirelessly with one another, for data or funds transfer, as FIG. 3 shows. Such cards, after authentication/verification, may also communicate wirelessly with a mobile device such as a phone, as shown in FIG. 3. If such a card is connected/inserted into one or more mobile devices, two or more such devices, after authentication/verification, may also communicate wirelessly with one another, as shown in FIG. 3.

What is claimed is:

1. A card that can connect, wirelessly or by contact, to a reader or to a computing device, mobile telephone or cellular telephone, said card permitting the flow of data to said card, from said card, or both when connected to said reader or to said computing device, after both fingerprint scanning authorization/user verification system, and image scanning authorization/user verification, or after image scanning authorization/user verification alone, said card including onboard fingerprint scanning authorization/user verification system, onboard image scanning authorization/user verification.

2. The card of claim 1 further comprising memory storage, a data processor, or both, in/on said card.

3. The card of claim 2 further comprising an application that effects transfer of funds/money to or from said card.

4. The card of claim 1 further comprising an application that effects transfer of funds/money or storage/transfer of medical information to or from said card.

5. The card of claim 1 wherein said card is contactless.

6. The connector device of claim 1 wherein fingerprint scanning authorization/user verification system, image scanning authorization/user verification, or both, is made through fingerprint sensors and image capture, and a comparison/matching program on/in said card or said reader or computing device.

7. The connector device of claim 1 wherein said card includes a display screen for data stored thereon/therein.

8. The card of claim 1 including a data storage chip and adapted for wireless communication through Internet connected devices and access points to merchants and financial institutions.

9. The card including a data storage chip and adapted for wireless communication with other such cards, with one or more mobile devices, or both.

10. A medical keyring device with dimensions of less than six inches long, two inches high and four inches wide comprises an inbuilt screen for displaying medical information; an on/off switch; a USB connector for connecting with computer devices; an inbuilt wi-fi chip to provide communication to computing devices; internal software records system management; an embedded silicon sensor, connected to an internal processor, for processing scanning and capture of a medical keyring user's fingerprint; and an internal rechargeable power supply that powers the internal processor, embedded sensor, or both.

11. The device of claim 10 further comprising an internal memory for storage of images and text, or of a user's fingerprint.

12. The device of claim 10 further comprising fingerprint memory connected to the device's internal processor.

13. The device of claim 10 further comprising a plurality of user authentication/verification routines including user fingerprint comparison to stored, known user fingerprints, password comparison to stored, known passwords, and voice recognition comparison to stored, known voice records.

14. The device of claim 10 further comprising internal memory of sufficient capacity to upload medical images, photographs, videos, and text records, protected from viewing, internet transmission or downloading by single or dual authentication.
